(19) United States
(12) Patent Application Publication
(10) Pub. No.: US 2026/0170049 A1
(43) Pub. Date: Jun. 18, 2026

(54) CONTENT SEARCHING

(71) Applicant: Beijing Zitiao Network Technology Co., Ltd., Beijing (CN)

(72) Inventors: Songyu Wang, Beijing (CN); Yanhan Jin, Beijing (CN)

(21) Appl. No.: 19/348,680

(22) Filed: Oct. 2, 2025

(30) Foreign Application Priority Data
Dec. 13, 2024 (WO) PCT/CN2024/139409

(51) Int. Cl. G06F 16/535; G06F 16/538; G06T 11/60

(52) U.S. Cl. CPC G06F 16/535; G06F 16/538; G06T 11/60; G06T 2200/24

(57) ABSTRACT

According to an embodiment of the disclosure, a method and an apparatus of content searching are provided. The method includes: receiving a search request from a user; and presenting, in response to the search request, a cover image of the media content in a search interface. Wherein the media content is determined based on a search request. The cover image is generated based on a plurality of images in the media content satisfying a predetermined condition.

### CROSS-REFERENCE

This application claims priority to International Patent Application No. PCT/CN2024/139409, filed on Dec. 13, 2024, and entitled "METHOD, APPARATUS, DEVICE, AND STORAGE MEDIUM FOR CONTENT SEARCHING", which is incorporated herein by reference in its entirety.

### FIELD

Example embodiments of the present disclosure generally relate to the field of computers, and in particular, to content searching.

### BACKGROUND

Content searching technology is a key support of the information age, and a core thereof is to efficiently and accurately extract information that users required from massive data. In the field of content searching, a cover image of the search result plays a crucial role for filtering content.

### SUMMARY

In a first aspect of the present disclosure, a method of content searching is provided. The method includes: receiving a search request from a user; and presenting, in response to the search request, a cover image of the media content in a search interface, the media content being determined based on the search request, the cover image being generated based on a plurality of images in the media content satisfying a predetermined condition.

In a second aspect of the present disclosure, an apparatus for content searching is provided. The apparatus includes: a receiving module configured to receive a search request from a user; and a presenting module configured to present, in response to the search request, a cover image of media content in a search interface, the media content being determined based on the search request, the cover image being generated based on a plurality of images in the media content satisfying a predetermined condition.

In a third aspect of the present disclosure, an electronic device is provided. The apparatus includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium has a computer program stored thereon, and the computer program is executable by the processor to implement the method of the first aspect.

It should be understood that the content described in this Summary is not intended to limit the key features or important features of the embodiments of the present disclosure, nor is it intended to limit the scope of the present disclosure. Other features of the present disclosure will be readily understood from the following description.

### BRIEF DESCRIPTION OF DRAWINGS

The above and other features, advantages, and aspects of various embodiments of the present disclosure will become more apparent with reference to the following detailed description taken in conjunction with the accompanying drawings. Throughout the drawings, the same or similar reference signs denote the same or similar elements, wherein:

FIG. 1 illustrates a schematic diagram of an example environment in which embodiments according to the present disclosure may be implemented;

FIGS. 2A-2C illustrate example interfaces for content searching according to some embodiments of the present disclosure;

FIG. 3 illustrates a flowchart of an example process of generating a cover image according to some embodiments of the disclosure;

FIG. 4 illustrates a flowchart of an example process of content searching according to some embodiments of the present disclosure;

FIG. 5 illustrates a schematic structural block diagram of an example apparatus for content searching according to some embodiments of the present disclosure; and

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the heading of any section/subsection provided in this article is not limiting. Various embodiments are described throughout herein, and any type of embodiments may be included in any section/subsection. Furthermore, the embodiments described in any section/subsection may be combined in any way with any other embodiments in the same section/subsection and/or any other embodiment described in different sections/subsections.

In the description of the embodiments of the present disclosure, the terms “including” and similar expressions should be understood as an open-ended inclusion, this is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or the same objects. Other explicit and implicit definitions may also be included below.

Embodiments of the present disclosure may relate to data of a user, acquisition and/or use of data, and the like. These aspects all comply with corresponding laws, regulations and related regulations. In the embodiments of the present disclosure, collection, obtaining, processing, processing, forwarding, use, etc. of all data, are performed with the user’s knowledge and confirmation. Accordingly, when implementing each embodiments of the present disclosure, users should be informed of the type, scope of use, usage scenarios, etc. that may be involved in the data or information and obtain their authorization through appropriate means in accordance with relevant laws and regulations. The specific notification and/or authorization methods may vary according to actual situations and application scenarios, and the scope of the present disclosure is not limited in this respect.

In the solutions in the present specification and the embodiments, if the processing of personal information is involved, the processing will be carried out on the premise of that is a basis of legality (for example, consent of the subject of the personal information is obtained, or it is necessary to fulfill a contract, etc.), and the processing will be carried out within the scope of the stipulations or agreements. The user refusing to process personal information other than that which is necessary for the basic functions will not affect the user’s use of the basic functions.

As mentioned above, content searching technology is a key support of the information age, and the core thereof is to efficiently and accurately extract the information that users required from massive data. In the field of content searching, the cover image of the search result plays a crucial role for filtering content.

The embodiment of the present disclosure provides a solution of content searching. The solution includes: receiving a search request from a user; and presenting, in response to the search request, a cover image of media content in a search interface. The media content is determined based on a search request, and the cover image is generated based on a plurality of images in the media content satisfying a predetermined condition.

In this way, the embodiments of the present disclosure can present more information in the search interface, thereby improving the efficiency of obtaining information.

Various example implementations of this solution are described in detail below in conjunction with reference to the accompanying drawings.

### Example Environment

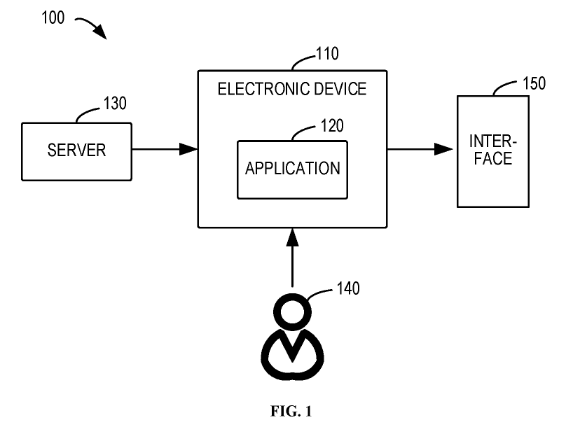

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports content searching. Application 120 may be any suitable type of application for content searching, examples of which may include, but are not limited to: social applications, content sharing applications, online video applications, or other suitable applications. The user 140 may interact with the application 120 via the electronic device 110 and/or its attachment device.

In the environment 100 of FIG. 1, in the case of the application 120 is in an active state, the electronic device 110 may present an interface 150 for supporting content searching through the application 120.

In some embodiments, the electronic device 110 communicates with the server 130 to enable provision of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game console, a virtual reality/augmented reality (VR/AR) device, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, or may be a server cluster or a distributed system that includes a plurality of physical servers, or may be a cloud server that provides basic cloud computing services such as cloud service, cloud database, cloud computing, cloud function, cloud storage, network service, cloud communication, middleware service, domain name service, security service, content distribution network, big data and artificial intelligence platform, and so on. The server 130 may include, for example, a computing system/server, such as a mainframe, an edge computing node, a computing device in a cloud environment, and the like. The server 130 may provide background services for the application 120 in the electronic device 110 that supports content searching.

A communication connection may be established between the server 130 and the electronic device 110. The communication connection may be established via a wired or wireless manner. The communication connection may include, but is not limited to, a Bluetooth connection, a mobile network connection, a universal serial bus (USB) connection, a wireless fidelity (Wi-Fi) connection, and so on. Embodiments of the present disclosure are not limited in this aspect. In the embodiment of the present disclosure, the server 130 and the electronic device 110 may implement signaling interaction through a communication connection in between.

It should be understood that the structures and functions of various elements in the environment 100 are described for illustrative purposes only and do not imply any limitation to the scope of the present disclosure.

Some example embodiments of the present disclosure will continue to be described below with continued reference to the accompanying drawings.

### Example Interaction

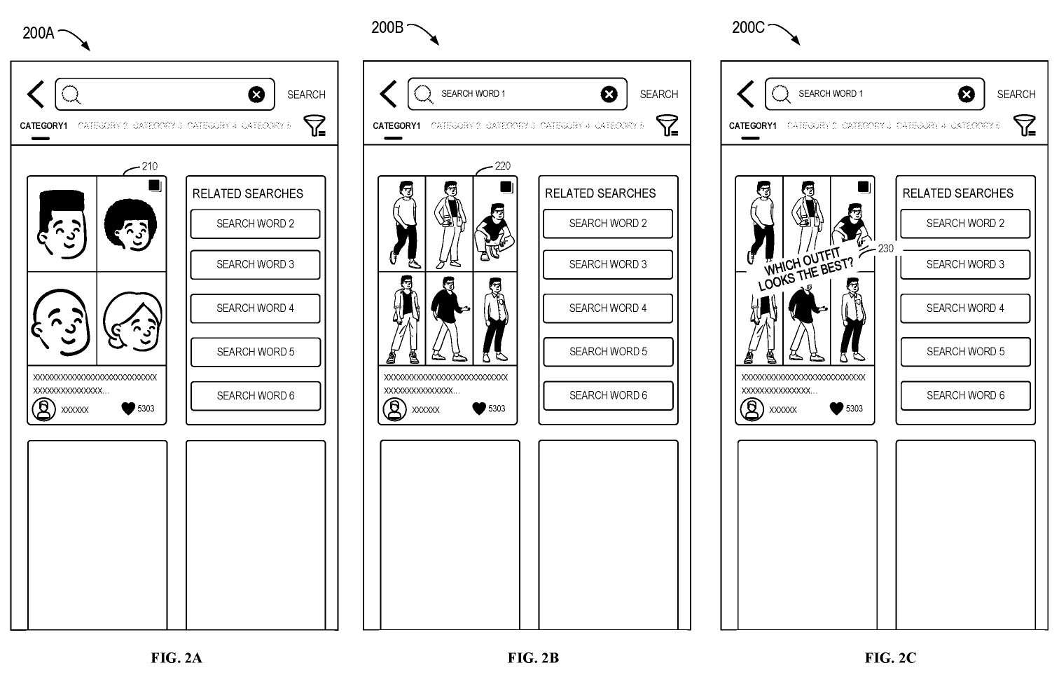

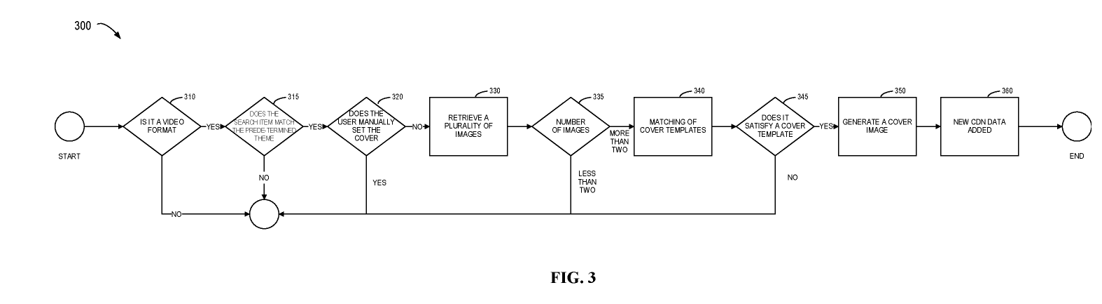

FIGS. 2A-2C illustrate example interfaces 200A-200C according to some embodiments of the present disclosure. The interface 200A to the interface 200C may be provided, for example, by the electronic device 110 shown in FIG. 1.

In some embodiments, the electronic device 110 receives a search request from a user. As an example, the electronic device 110 may obtain, via a search component in any appropriate interface, a search request input by the user 140 through a search component, wherein the search request may be, for example, a search term input by the user 140. Such a search term may be, for example, text content (e.g., “hairstyle”, “outfit”, “how to make tomato scrambled eggs”, etc.) or image content (e.g., hairstyle images, shirts images, etc.). The interface where the search component is located may be, for example, an interface for presenting an information flow.

In some embodiments, after the electronic device 110 receives a search request, the electronic device 110 may present a cover image of a search result. Specifically, the electronic device 110 presents the cover image of the media content in the search interface in response to the search request. The media content is determined based on the search request. The cover image is generated based on a plurality of images in the media content satisfying a predetermined condition. Such a plurality of images may be, for example, at least part images cropped by server 130 from a plurality of video frames associated with media content. For example, the server 130 may crop the image part associated with the predetermined object from a target video frame.

As an example, after the electronic device 110 receives a search term (i.e., the search request), the electronic device 110 may present the interface 200A as shown in FIG. 2A, and the interface 200A may be a search result interface associated with the search term. The interface 200A includes the cover image 210. The cover image 210 is associated with the media content. Such media content may be, for example, text content, video content, image content, image and text content, or the like.

In some scenarios, a search term may be “hairstyle”. After receiving the word “hairstyle”, the electronic device 110 may obtain the media content associated with the “hairstyle”, and present the cover image 210 of the media content associated with the “hairstyle” in the interface 200A. The cover image 210 may be stitched by a plurality of images associated with “hairstyle” of the media content.

The cover image in the interface 200A may be manually set by a poster of the media content, or may be automatically generated by the server 130 based on a plurality of images in the media content satisfying a predetermined condition. Such a predetermined condition may indicate, for example, image quality (for example, resolution, brightness and image ratio) of the plurality of images, whether a genre of the media content satisfies a predetermined genre, whether the media content has been set to a cover image, and the like.

In some embodiments, the cover image in interface 200A may be generated by server 130 based on a cover template. Specifically, the server 130 may determine the cover template corresponding to the number based on the number of the plurality of images. Furthermore, the server 130 may generate the cover image based on the cover template and the plurality of images.

As an example, after the plurality of images in the media content are obtained, the server 130 may determine the number of images among the plurality of images, and determine a target cover template based on the number of images. For example, after the server 130 determines that the number of images among the plurality of images is 4, the server 130 may obtain the cover template of the four-square grid. Further, the server 130 may adjust the image ratio of the four images to ensure that the image ratio of the four images satisfies the requirement of the four-square grid template. Finally, the server 130 may fill the four images, after the image ratio adjustment, to the content of the four-square grid template to generate the cover image.

In some scenarios, after the server 130 obtains six images from the media content, the server 130 may select the cover template of the six-square grid to generate a cover image. After generating the cover image, the server 130 may send the cover image to the electronic device 110, such that the electronic device 110 can present the cover image 220 as shown in FIG. 2B.

Additionally, or alternatively, after determining a plurality of images from the media content, the server 130 may superimpose the plurality of images to generate an image set. The server 130 may use the image set as a cover image of the media content, and the image set includes a first image and a second image. The electronic device 110 may present the image set in a search result interface. When the image set is presented, the electronic device 110 may use the first image as the cover of the image set by default. After receiving the selection of the second image by the user, the electronic device 110 may switch the first image to the second image, such that the user can preview the media and the content more conveniently.

In some embodiments, the server 130 not only determines a cover template based on the number of the plurality of images, but also determines the cover template based on the aspect ratio of the plurality of images. Specifically, the cover template is further associated with the aspect ratio information of the plurality of images. As an example, the server 130 may determine that the plurality of images are horizontally oriented images or vertically oriented images based on the image ratios of the plurality of images. Moreover, the server 130 may select a cover template corresponding to the horizontally oriented images or the vertically oriented images. For example, the plurality of images are horizontally oriented images, and the server 130 may arrange and stitch the plurality of horizontally oriented images from top to bottom to generate the cover image.

In some embodiments, the electronic device 110 may also present text elements associated with the cover image to the user. The text elements are generated by the server 130 based on the media content and/or the plurality of images.

As an example, as shown in FIG. 2C, the server 130 may determine theme information corresponding to the media content or the plurality of images, and the theme information may be, for example, the “outfit”. When the server 130 determines the theme information as "outfit", the server 130 may generate the text element 230 based on the “outfit” and superimpose the text elements on the cover image. Such text elements may be, for example, “Which outfit looks best?”. In this way, the embodiments of the present disclosure can enrich the content included in the cover image, thereby improving efficiency of obtaining information.

In some embodiments, a text element may also be determined based on the search request. As an example, the search term may be, for example, “hairstyle suitable for boy”. After receiving the phrase “hairstyle suitable for boy”, the server 130 may generate an associated text element, for example, may be “ten hairstyles most suitable for boy this summer”.

In this way, the embodiments of the present disclosure can present more information in the search interface, thereby improving efficiency of obtaining information.

### Example Process of Generating a Cover Image

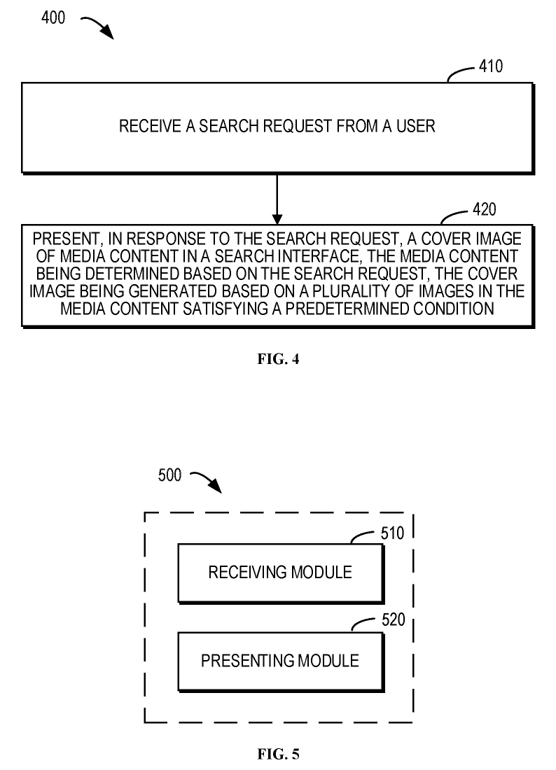

FIG. 3 illustrates a flowchart of an example process 300 of a cover image according to some embodiments of the present disclosure. Process 300 may be implemented in server 130. The process 300 is described below with reference to FIG. 1.

In some embodiments, the server 130 may determine, in response to at least one condition being satisfied, a plurality of images satisfying a predetermined condition from the media content to generate the cover image. The at least one condition includes at least one of a genre of media content satisfying a first constraint, a search request being associated with a predetermined theme, no cover image is set for the media content, and a set cover image for the media content fails to satisfy a second constraint. The second constraint is associated with an image quality and/or image content of the set cover image. The first constraint may be, for example, whether a genre of the media content is an appropriate genre of video content, image and text content, image content, or the like. The predetermined theme may be, for example, an experience-driven decision theme, and the experience-driven decision theme may indicate a category such as cooking experience, outfit experience, and travel experience. For example, the second constraint may indicate that the resolution, the brightness, the image ratio, the image content, and the like of the set cover image for the media content fails to satisfy a predetermined requirement. For example, the resolution of the set cover image is lower than a predetermined value, or the image has obvious distortion, and so on. The predetermined requirement may be set by a person skilled in the art, and the present disclosure is not limited thereto.

As an example, as shown in FIG. 3, the server 130 may first perform multi-round judgment on the media content, for example, judgement 310-330. The judgment 310 is to judge whether the genre of the media content satisfies the first constraint. The judgment 320 is to judge whether the search request is associated with a predetermined theme, and the judgment 330 is to judge whether the media content has a cover manually set by the user. After the multi-round judgment, the server 130 may perform the task 330 to extract the plurality of images 330 from the media content. Further, the server 130 may generate a cover image based on the plurality of extracted images. In this way, the embodiment of the present disclosure can effectively improve the quality of the generated cover image.

In some embodiments, when obtaining the plurality of images from the media content, the server 130 may determine the plurality of images to be obtained based on the description information of the media content. Specifically, the server 130 may obtain description information of the media content. Furthermore, the server 130 may determine, from the image set of media content, a plurality of images satisfying a predetermined condition. The predetermined condition indicates that a correlation between the plurality of images and the description information is greater than a first threshold. The description information indicates at least a theme of the media content.

As an example, the server 130 may first determine description information of the media content, and the description information may be derived from content such as a title and a text uploaded by a blogger, or may be a description generated by understanding the media content with the help of a model. Such description information may, for example, indicate a content category (i.e., theme) of the media content. For example, the content category may be, for example, content related to outfits, hairstyles, or any type of product. Taking the theme of the media content being the outfit content as an example, after the theme of the media content is determined to be the outfit content, the server 130 may obtain, from the media content, a plurality of images associated with the outfit (that is, a plurality of images with a correlation greater than a first threshold with the description information). The image associated with the outfit may be, for example, an image of a model worn shirt or an image of a model worn down jacket, or the like. If the media content further includes the content of the hairstyle introduction, the server 130 does not obtain the image related to the hairstyle introduction.

In some scenarios, the media content may be, for example, video content for making meals. When obtaining the plurality of images, the server 130 may segment the media content. For example, the video content of making delicious food includes a plurality of production stages, and the production stage may be, for example, a vegetable cutting stage, a kneading stage, a cooking stage, and a baking stage. The server 130 may extract one frame of image in the vegetable cutting stage, the kneading stage, the cooking stage and the baking stage, respectively, to obtain a plurality of image frames for generating the cover image.

In this way, embodiments of the present disclosure can effectively improve recall accuracy of a plurality of images in media content.

In some embodiments, when obtaining the plurality of image content from the media content, the server 130 needs to ensure that the visual similarity between the plurality of images is less than a second threshold and/or the semantic similarity of the plurality of images is less than a third threshold. As an example, the media content is a video for cooking, and the media content includes a plurality of stages, for example, a vegetable cutting stage, a cooking stage, and a soup cooking stage. When selecting the plurality of images for generating the cover image, the server 130 selects one image in a vegetable cutting stage, a cooking stage and a soup cooking stage without selecting a plurality of images in the vegetable cutting stage to ensure that the semantic similarity between the plurality of images is less than the third threshold.

Additionally, or alternatively, the media content is a video that introduces outfits, and the media content includes an image of a model wearing a plurality of clothing (e.g., wearing down jacket, wearing a short sleeve or wearing a dress, etc.). When selecting the plurality of images for generating the cover image, the server 130 may select one image from each image of the model wearing down jacket, wearing the short sleeve, and wearing the dress, respectively, thereby ensuring that the visual similarity between the plurality of images is less than the second threshold. The second threshold may be set by a person skilled in the art according to requirements, which is not limited in the present disclosure.

In some embodiments, the plurality of images may be determined not only based on the description information of the media content, but also based on the search request. As an example, the server 130 may receive a search term input by a user through the electronic device 110. Further, the server 130 may obtain a plurality of images associated with the search term from the media content. For example, if the search term is “male hairstyle”, the server 130 may obtain a plurality of images (for example, an image of a crew cut, an image of a buzz cut, an image of an oblique fringe hairstyle, etc. ) associated with “male hairstyle” from the media content.

In some scenarios, when the media content includes a plurality of themes, the server 130 may determine, based on the target theme indicated by the received search request, a plurality of images corresponding to the target theme from the media content, to generate the cover image. For example, the target theme indicated by the search request is a “ theme, and the media content includes an outfit theme and a hairstyle theme. Then, after receiving the search request, the server 130 may obtain a plurality of images associated with the outfit theme from the media content, without obtaining an image associated with the hairstyle theme.

In some embodiments, as shown in FIG. 3, after the plurality of images in the media content are determined, the server 130 may perform a judgement 335 to determine the number of the plurality of images. When the number of the plurality of images is more than two, the server 130 may perform the task 340 to perform the determination of the cover template based on the number and/or the aspect ratio corresponding to the plurality of images.

After the cover template is determined, the server 130 may perform the judgement 345 to determine whether the plurality of images satisfy the requirement of the determined cover template. The requirement of the cover template may be, for example, a requirement for aspect ratio, ratio, and content of the plurality of images.

After the plurality of images obtained by the server 130 satisfy the requirements of the cover template, the server 130 may perform the task 350 based on the determined cover template and the plurality of images to generate the cover image. Furthermore, the server 130 may perform the task 360 to store the generated cover image in a database.

In this way, the embodiments of the present disclosure can stitch the plurality of images in the media content into the cover image, and increase the information included in the cover image, thereby improving obtaining efficiency of the information.

### Example Processes

FIG. 4 illustrates a flowchart of an example process 400 of content searching according to some embodiments of the present disclosure. Process 400 may be implemented at electronic device 110. The process 400 is described below with reference to FIG. 1.

As shown in FIG. 4, at block 410, the electronic device 110 receives a search request from a user.

At block 420, the electronic device 110 presents, in response to the search request, a cover image of the media content in a search interface, the media content being determined based on a search request, the cover image being generated based on a plurality of images in the media content satisfying a predetermined condition.

In some embodiments, the cover image is generated through: determining, based on a number of the plurality of images, a cover template corresponding to the number; and generating the cover image based on the cover template and the plurality of images.

In some embodiments, the cover template is further associated with aspect ratio information of the plurality of images.

In some embodiments, the cover image further includes a text element generated based on at least one of the media content or the plurality of images.

In some embodiments, the text content corresponding to the text element is further determined based on the search request.

In some embodiments, the plurality of images are determined through: obtaining description information of the media content; and determining a plurality of images satisfying a predetermined condition from the image set of the media content, the predetermined condition indicating that a correlation between the plurality of images and the description information is greater than a first threshold.

In some embodiments, the description information indicates at least a theme of the media content.

In some embodiments, the plurality of images are determined based on the search request.

In some embodiments, the visual similarity between the plurality of images is less than the second threshold and/or the semantic similarity of the plurality of images is less than a third threshold.

In some embodiments, the cover image is generated through: determining, in response to at least one condition being satisfied, a plurality of images satisfying a predetermined condition from the media content to generate a cover image, the at least one condition including at least one of the following: a genre of the media content satisfies a first constraint; the search request associated with a predetermined theme; no cover image is set for the media content; or a set cover image set for the media content fails to satisfy a second constraint.

In some embodiments, the second constraint is associated with at least one of an image quality or image content of the set cover image.

### Example Apparatus and Devices

Embodiments of the present disclosure also provide a corresponding apparatus for implementing the above method or process. FIG. 5 illustrates a schematic structural block diagram of an example apparatus 500 for content searching according to some embodiments of the present disclosure. The apparatus 500 may be implemented or included in the electronic device 110. The various modules/components in the apparatus 500 may be implemented by hardware, software, firmware, or any combination thereof.

As shown in FIG. 5, the apparatus 500 includes: a receiving module 510, configured to receive a search request from a user; and a presenting module 520, configured to present, in response to the search request, a cover image of the media content in the search interface, the media content being determined based on the search request, and the cover image being generated based on a plurality of images in the media content satisfying a predetermined condition.

In some embodiments, the cover image is generated through: determining, based on a number of the plurality of images, a cover template corresponding to the number; and generating the cover image based on the cover template and the plurality of images.

In some embodiments, the cover template is further associated with aspect ratio information of the plurality of images.

In some embodiments, the cover image further includes a text element generated based on at least one of the media content or the plurality of images.

In some embodiments, the text content corresponding to the text element is further determined based on the search request.

In some embodiments, the plurality of images are determined through: obtaining description information of the media content; and determining, a plurality of images satisfying a predetermined condition from the image set of the media content, the predetermined condition indicating that a correlation between the plurality of images and the description information is greater than a first threshold.

In some embodiments, the description information indicates at least a theme of the media content.

In some embodiments, the plurality of images are determined based on the search request.

In some embodiments, the visual similarity between the plurality of images is less than the second threshold and/or the semantic similarity of the plurality of images is less than the third threshold.

In some embodiments, the cover image is generated through: determining, in response to at least one condition being satisfied, a plurality of images satisfying a predetermined condition from the media content to generate a cover image, the at least one condition including at least one of the following: a genre of the media content satisfies a first constraint; the search request associated with a predetermined theme; no cover image is set for the media content; or a set cover image for the media content fails to satisfy a second constraint.

In some embodiments, the second constraint is associated with at least one of an image quality or image content of the set cover image.

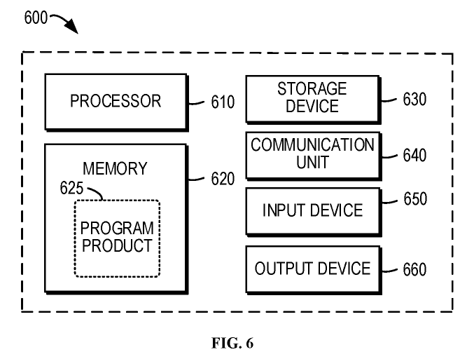

As shown in FIG. 6, the electronic device 600 is in the form of a general-purpose electronic device. Components of the electronic device 600 may include, but are not limited to, one or more processing units or processors 610, a memory 620, a storage device 630, one or more communication units 640, one or more input devices 650, and one or more output devices 660. The processor 610 may be an actual or virtual processor and capable of performing various processes according to programs stored in the memory 620. In multiprocessor systems, multiple processors execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. Storage device 630 may be a removable or non-removable medium and may include a machine-readable medium, such as a flash drive, magnetic disk, or any other medium, which may be used to store information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 is configured to communicate with another electronic device over a communication medium. Additionally, the functionality of components of the electronic device 600 may be implemented in a single computing cluster or a plurality of computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc. , communicate with one or more devices that enable a user to interact with the electronic device 600, or communicate with any device (e.g., a network card, a modem, etc. ) that enables the electronic device 600 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/actions specified in one or more blocks of the flowchart and/or block diagram (s).

The computer-readable program instructions may be loaded onto a computer, other programmable data processing apparatus, or other apparatus, causing a series of operational steps to be performed on a computer, other programmable data processing apparatus, or other apparatus to produce a computer-implemented process such that the instructions, when executed on a computer, other programmable data processing apparatus, or other devices implement the functions/acts specified in the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions marked in the blocks may also occur in a different order than marked in the drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented using a combination of dedicated hardware and computer instructions.

Various implementations of the present disclosure have been described above, and the foregoing description is illustrative, not exhaustive, and is not limited to the implementations as disclosed. Many modifications and variations will be apparent to those of ordinary skill in the art without departing from the scope and spirit of the illustrated implementations. The terminology used herein has been chosen to best explain the principles of the implementations, practical applications, or improvements to techniques in the marketplace, or to enable those skilled in the art to understand the various implementations disclosed herein.

1. A method for content searching, comprising:
receiving a search request from a user; and
presenting, in response to the search request, a cover image of media content in a search interface, the media content being determined based on the search request, the cover image being generated based on a plurality of images in the media content satisfying a predetermined condition.

2. The method of claim 1, wherein the cover image is generated through:
determining, based on a number of the plurality of images, a cover template corresponding to the number; and
generating the cover image based on the cover template and the plurality of images.

3. The method of claim 2, wherein the cover template is further associated with aspect ratio information of the plurality of images.

4. The method of claim 1, wherein the cover image further comprises a text element generated based on at least one of the media content or the plurality of images.

5. The method of claim 4, wherein text content corresponding to the text element is further determined based on the search request.

6. The method of claim 1, wherein the plurality of images are determined through:
obtaining description information of the media content; and
determining the plurality of images satisfying the predetermined condition from an image set of the media content, the predetermined condition indicating that a correlation between the plurality of images and the description information is greater than a first threshold.

7. The method of claim 6, wherein the description information indicates at least a theme of the media content.

8. The method of claim 1, wherein the plurality of images are determined based on the search request.

9. The method of claim 1, wherein a visual similarity between the plurality of images is less than a second threshold and/or a semantic similarity of the plurality of images is less than a third threshold.

10. The method of claim 1, wherein the cover image is generated through:
determining, in response to at least one condition being satisfied, the plurality of images satisfying the predetermined condition from the media content to generate the cover image, the at least one condition comprising at least one of the following:
a genre of the media content satisfies a first constraint;
the search request is associated with a predetermined theme;
no cover image is set for the media content; or
a set cover image for the media content fails to satisfy a second constraint.

11. The method of claim 10, wherein the second constraint is associated with at least one of an image quality or image content of the set cover image.

12. An electronic device, comprising:
at least one processor; and
at least one memory coupled to the at least one processor and storing instructions for execution by the at least one processor, the instructions, when executed by the at least one processor, causing the electronic device to perform acts comprising:
receiving a search request from a user; and
presenting, in response to the search request, a cover image of media content in a search interface, the media content being determined based on the search request, the cover image being generated based on a plurality of images in the media content satisfying a predetermined condition.

13. The electronic device of claim 12, wherein the cover image is generated through:
determining, based on a number of the plurality of images, a cover template corresponding to the number; and
generating the cover image based on the cover template and the plurality of images.

14. The electronic device of claim 13, wherein the cover template is further associated with aspect ratio information of the plurality of images.

15. The electronic device of claim 12, wherein the cover image further comprises a text element generated based on at least one of the media content or the plurality of images.

16. The electronic device of claim 15, wherein text content corresponding to the text element is further determined based on the search request.

17. The electronic device of claim 12, wherein the plurality of images are determined through:
obtaining description information of the media content; and
determining the plurality of images satisfying the predetermined condition from an image set of the media content, the predetermined condition indicating that a correlation between the plurality of images and the description information is greater than a first threshold.

18. The electronic device of claim 17, wherein the description information indicates at least a theme of the media content.

19. The electronic device of claim 12, wherein the plurality of images are determined based on the search request.

20. A non-transitory computer-readable storage medium having a computer program stored thereon, wherein the computer program is executable by a processor to implement acts comprising:
receiving a search request from a user; and
presenting, in response to the search request, a cover image of media content in a search interface, the media content being determined based on the search request, the cover image being generated based on a plurality of images in the media content satisfying a predetermined condition.
